(19) United States
(12) Patent Application Publication
(10) Pub. No.: US 2007/0252791 A1
(43) Pub. Date: Nov. 1, 2007

(54) Charge pump type display drive device

(76) Inventor: Tetsuro Oomori, Osaka (JP)

Correspondence Address: MCDERMOTT WILL & EMERY LLP, 600 13TH STREET, NW, WASHINGTON, DC, 20005-3096, US

(21) Appl. No.: 11/790,332

(22) Filed: Apr. 25, 2007

(30) Foreign Application Priority Data
Apr. 28, 2006 (JP) 2006-125547
Mar. 5, 2007 (JP) 2007-054021

(51) Int. Cl. G09G 3/30

(52) U.S. Cl. 345/76

(57) ABSTRACT

An anode drive circuit is provided for each of organic EL elements constituting one row on a passive display panel. The anode drive circuit includes: a capacitor; two switches for permitting the capacitor to store charge by applying a charge voltage to a high-voltage terminal of the capacitor while holding a low-voltage terminal of the capacitor at a reference voltage; and two switches for permitting the capacitor to release charge stored therein by connecting the high-voltage terminal to an anode of an organic EL element while applying a voltage higher than a light emission threshold voltage of the organic EL element to the low-voltage terminal. The number of times of repetition of charge/discharge of the capacitor within one horizontal time period is controlled so as to control the light emission luminance of the organic EL element according to a data signal.

### BACKGROUND OF THE INVENTION

The present invention relates to a charge pump type display drive device, and more particularly, to a technology of driving an electroluminescence (EL) display panel.

An organic EL display panel is known as one of current drive type display devices. Each organic EL element won't emit light with a current hardly flowing thereinto if the drive voltage is lower than a light emission threshold voltage (forward voltage) of the organic EL element. If the drive voltage is higher than the light emission threshold voltage, the organic EL element emits light at a luminance roughly proportional to the drive current flowing thereinto.

There is known a passive organic EL display panel, that is, a display panel having no transistor for control inside each pixel composed of an organic EL element. In some conventional technology, the anodes of individual organic EL elements constituting one row of the display panel are connected to constant current sources via switches in a display drive device external to the passive display panel. In other words, each organic EL element is driven with transistors constituting a constant current source (see Japanese Laid-Open Patent Publication No. 2002-229511).

In the conventional configuration in which organic EL elements are driven with transistors, the current accuracy depends on the accuracy of the transistors, which in turn depends on the areas of the transistors. Therefore, to secure high accuracy for the drive current of individual organic EL elements, the areas of a number of transistors must be increased. This conventionally blocks attainment of reduction in the cost and size of the display drive device. Another problem is that the characteristics of transistors greatly depend on the temperature.

### SUMMARY OF THE INVENTION

An object of the present invention is attaining reduction in the cost and size of a display drive device for a passive display panel.

To achieve the above object, according to the present invention, a charge pump configuration using capacitors is adopted as a display drive device for driving a passive display panel having a plurality of organic EL elements arranged in a matrix as pixels with no transistor for control provided inside each pixel. According to one aspect of the invention, the display drive device includes a plurality of drive circuits provided to correspond to respective organic EL elements constituting one row on the display panel, wherein each of the drive circuits includes: a capacitor having first and second terminals; charge means for permitting the capacitor to store charge by applying a predetermined voltage to the second terminal of the capacitor while holding the voltage of the first terminal of the capacitor at a reference voltage; discharge means for permitting the capacitor to release charge stored therein by connecting the second terminal of the capacitor to an anode of a corresponding organic EL element on the display panel while applying a voltage higher than a light emission threshold voltage of the corresponding organic EL element on the display panel to the first terminal of the capacitor so that a current flows into the corresponding organic EL element on the display panel to allow the organic EL element to emit light; charge/discharge control means for controlling the number of times of repetition of charge/discharge of the capacitor within a time period during which organic EL elements constituting one row on the display panel are driven so as to control the light emission luminance of the corresponding organic EL element on the display panel according to a data signal given.

According to the present invention, a current can be fed to an organic EL element by charge pump driving using a capacitor. With this, reduction in the cost and size of a display drive device for a passive display panel can be easily attained compared with the case of using current source transistors.

### BRIEF DESCRIPTION OF THE DRAWINGS

FIG. 1 is a block diagram of an exemplary charge pump type display drive device of the present invention.

FIG. 2 is an operation timing chart of the charge pump type display drive device of FIG. 1.

FIG. 3 is a block diagram of a first alteration to the charge pump type display drive device of FIG. 1.

FIG. 4 is an operation timing chart of the charge pump type display drive device of FIG. 3.

FIG. 5 is a block diagram of a second alteration to the charge pump type display drive device of FIG. 1.

FIG. 6 is an operation timing chart of the charge pump type display drive device of FIG. 5.

FIG. 7 is a block diagram of a third alteration to the charge pump type display drive device of FIG. 1.

FIG. 8 is an operation timing chart of the charge pump type display drive device of FIG. 7.

### DESCRIPTION OF THE PREFERRED EMBODIMENTS

Hereinafter, a preferred embodiment of the present invention will be described with reference to the accompanying drawings.

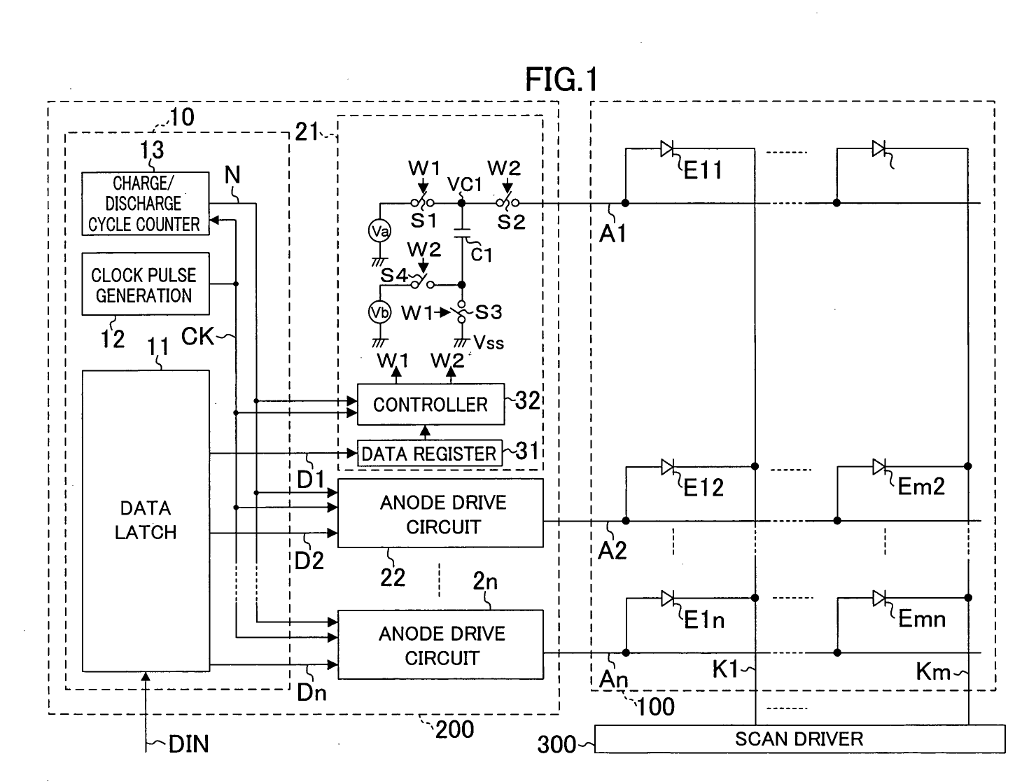

FIG. 1 shows an exemplary configuration of a charge pump type display drive device of the present invention. Referring to FIG. 1, a display panel 100, a data driver 200 and a scan driver 300 constitute one display apparatus.

The display panel 100 is a passive display panel that has n×m organic EL elements arranged in a matrix as pixels where n and m are integers and does not have any transistor for control in each pixel. The cathodes of n organic EL elements E11, E12, . . . , E1n constituting the first row (first horizontal line on a screen) are commonly connected to a first cathode line K1. The cathodes of n organic EL elements Em1, Em2, . . . , Emn constituting the m-th row (m-th horizontal line on a screen) are commonly connected to an m-th cathode line Km. Also, the anodes of m organic EL elements E11, . . . , Em1 constituting the first column are commonly connected to a first anode line A1, the anodes of m organic EL elements E12, . . . , Em2 constituting the second column are commonly connected to a second anode line A2, and the anodes of m organic EL elements E1n, . . . , Emn constituting the n-th column are commonly connected to an n-th anode line An.

The scan driver 300 is a driver that selects the cathodes of n organic EL elements constituting each row on the display panel 100 sequentially in rows. More specifically, the voltages of the m cathode lines K1, . . . , km are lowered to the ground voltage Vss in a sequential selective manner.

The data driver 200 is a charge pump type display drive device of the present invention for driving the display panel 100, which includes a drive control circuit 10 and n anode drive circuits 21, 22, . . . , 2n provided to correspond to n organic EL elements constituting one row on the display panel 100. The drive control circuit 10 includes a data latch 11, a clock pulse generation circuit 12 and a charge/discharge cycle counter 13.

The first anode drive circuit 21 includes a capacitor Cl, switches S1, S2, S3 and S4 for permitting the capacitor C1 to store charge and release stored charge, a data register 31 and a charge/discharge controller 32. The switches S1, S2, S3 and S4 are respectively a charge switch, a discharge switch, a low-side voltage switch for charge, and a low-side voltage switch for discharge.

The low-voltage side terminal (first terminal) of the capacitor C1 is connected to the ground voltage (reference voltage) Vss via the low-side voltage switch S3 for charge. The high-voltage side terminal (second terminal) of the capacitor C1 is configured to receive a predetermined charge voltage Va via the charge switch S1. During charging of the capacitor C1, a switch control signal W1 goes active to turn ON the switches S1 and S3, so that an amount of charge corresponding to the charge voltage Va is stored in the capacitor C1.

The low-voltage side terminal of the capacitor C1 is configured to receive a predetermined low-side voltage Vb for discharge via the low-side voltage switch S4 for discharge. The low-side voltage Vb for discharge is set to be higher than a light emission threshold voltage of the organic EL elements on the display panel 100. The high-voltage side terminal of the capacitor C1 is connected to the first anode line A1 via the discharge switch S2. During discharging of the capacitor C1, a switch control signal W2 goes active to turn ON the switches S2 and S4, so that the high-voltage side terminal of the capacitor C1 is connected to the first anode line A1 while the voltage Vb higher than the light emission threshold voltage is applied to the low-voltage side terminal of the capacitor C1. As a result, the entire charge stored in the capacitor C1 in response to the charge voltage Va flows through one organic EL element, among the m organic EL elements E11, . . . , Em1 constituting the first column on the display panel 100, the voltage of the cathode of which has been lowered to the ground voltage Vss with the scan driver 300, as a drive current, permitting the organic EL element in question to emit light.

The data register 31 holds a first data signal D1 given from the data latch 11. The first data signal D1 is a signal representing data of eight bits, for example, specifying the light emission luminance of the corresponding organic EL element on the display panel 100. The charge/discharge cycle counter 13 operates in response to a clock signal CK supplied from the clock pulse generation circuit 12, counts the number of repetition cycles of charge/discharge of the capacitor C1 within the time period during which the organic EL elements of one row on the display panel 100 are operated (one horizontal time period), and supplies a count signal N representing the count value (from 0 to 255) to the charge/discharge controller 32. The charge/discharge controller 32 generates pulses of the switch control signals W1 and W2 in response to the clock signal CK supplied from the clock pulse generation circuit 12, and also operates to stop the generation of pulses of the switch control signals W1 and W2 at and after the time when the count value represented by the count signal N exceeds the data represented by the first data signal D1. In this way, the number of times of repetition of charge/discharge of the capacitor C1 within one horizontal time period is controlled so as to control the light emission luminance of the corresponding organic EL element on the display panel 100 in response to the first data signal D1.

The other (n−1) anode drive circuits 22, . . . , 2n, having substantially the same internal configuration as the first anode drive circuit 21, respectively receive the clock signal CK from the clock pulse generation circuit 12 and the count signal N from the charge/discharge cycle counter 13. Also, the second anode drive circuit 22 receives a second data signal D2, and the n-th anode drive circuit 2n receives an n-th data signal Dn, from the data latch 11. The data latch 11 latches an input data signal DIN for one line on the screen, and distributes the data signals D1, D2, . . . , Dn to the anode drive circuits 21, 22, . . . , 2n.

Note that description on a means of securing synchronization between the data driver 200 and the scan driver 300 is omitted herein.

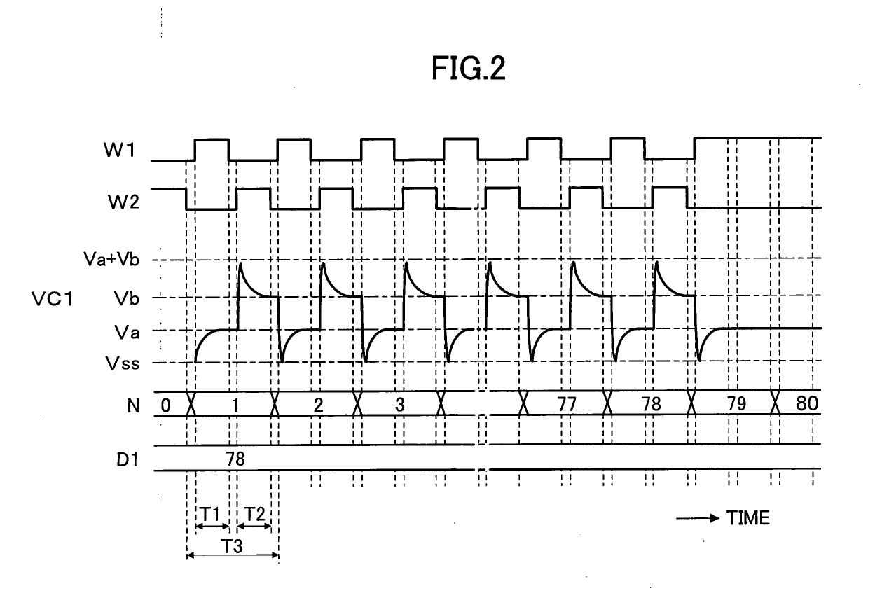

FIG. 2 is an operation timing chart of the anode drive circuit 21 in FIG. 1. Assume herein that the first cathode line K1 is being selected with the scan driver 300.

As shown in FIG. 2, during time period T1 when the control signal W1 for the charge switch S1 and the low-side voltage switch S3 for charge is active, the voltage VC1 of the high-voltage side terminal of the capacitor C1 (hereinafter, this voltage is simply called a “capacitor voltage”) changes from Vss to Va. That is, charge Q1=C1×Va is stored in the capacitor C1.

After the switch control signal W1 has become inactive to turn OFF the charge switch S1 and the low-side voltage switch S3 for charge, the control signal W2 for the discharge switch S2 and the low-side voltage S4 for discharge become active during time period T2. During this time, the capacitor voltage VC1 once rises to Va+Vb and then falls to Vb by discharging. In other words, since the low-side voltage Vb for discharge is set at a voltage higher than the light emission threshold voltage of the organic EL element E11 on the display panel 100, the entire charge Q1 stored in the capacitor C1 is allowed to flow into the organic EL element E11 to permit the organic EL element E11 to light.

When the period of one charge/discharge cycle composed of the time periods T1 and T2 is T3, the average drive current I1 of the organic EL element E11 during the period T3 is expressed by

I1=Q1/T3=C1×Va/T3.

Such a charge/discharge cycle continues until the count value represented by the count signal N becomes equal to data (for example, 78) represented by the first data signal D1. Once the count value represented by the count signal N exceeds the above data, the switch control signals W1 and W2 are fixed to active and inactive, respectively. After this fixation, the capacitor voltage VC1 does not exceed Va within one horizontal time period, stopping the current drive of the organic EL element E11. Therefore, the average drive current I1′ of the organic EL element E11 in one horizontal time period is expressed by

I1′=I1×D1/255,

which gives the average light emission luminance corresponding to the 8-bit first data signal D1. In other words, a linear data-luminance characteristic is attained.

As described above, in the configuration of FIG. 1, with the charge pump driving using capacitors, a highly accurate current corresponding to data given can be fed to organic EL elements, and thus reduction in the cost and size of the data driver 200 can be attained. Note that the data driver 200 may be divided and mounted on LSIs of the number corresponding to the number of anode drive circuits.

Human eyes are sensitive to a change in luminance when the luminance is low and not so sensitive when it is high. A nonlinear data-luminance characteristic considering such a human vision characteristic may sometimes be required. In view of this, a configuration for implementing a nonlinear data-luminance characteristic will be discussed.

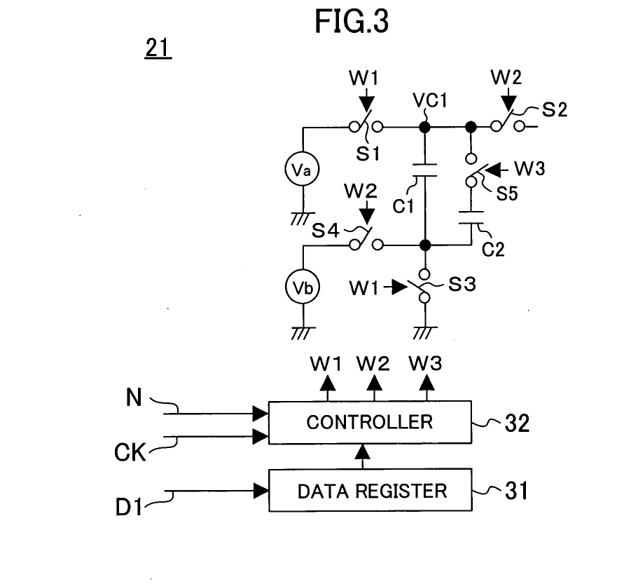

FIG. 3 shows a first alteration to the charge pump type display drive device of FIG. 1. An anode drive circuit 21 of FIG. 3, which changes the combined capacitance value of capacitors according to the count signal N, includes first and second capacitors C1 and C2 and also additionally includes a capacitor selection switch S5 that receives a control signal W3. The serial circuit composed of the second capacitor C2 and the capacitor selection switch S5 is connected in parallel with the first capacitor C1. The charge/discharge controller 32 generates the switch control signal W3 so that the capacitor selection switch S5 is OFF when the count value represented by the count signal N is equal to or less than 16, for example, and is ON when it is greater than 16.

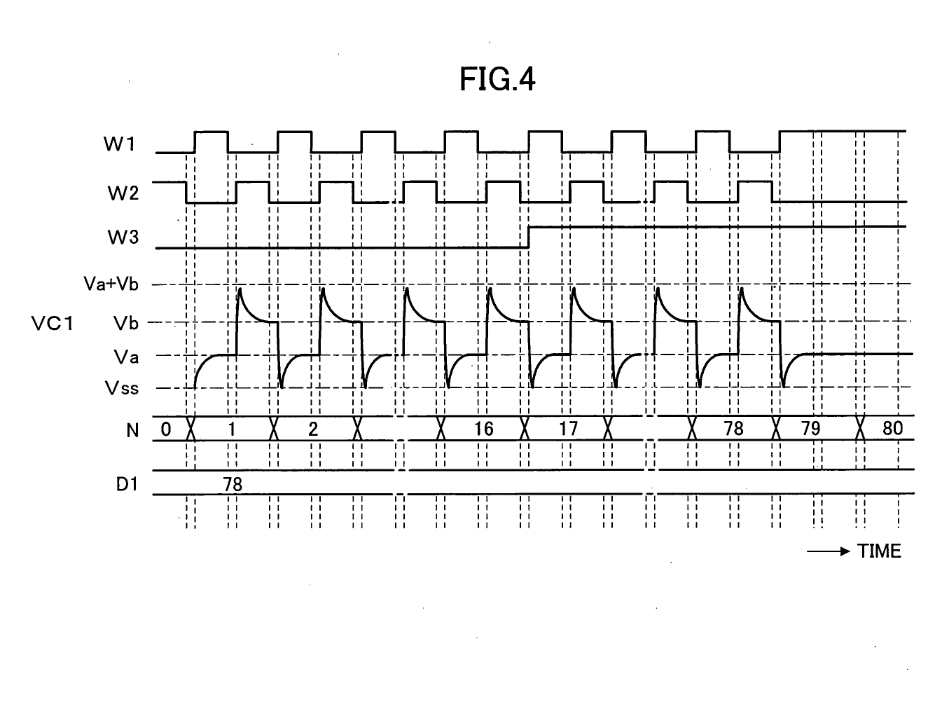

FIG. 4 is an operation timing chart of the anode drive circuit 21 of FIG. 3. During the time when the count value represented by the count signal N is any of 0 to 16, the capacitor selection switch S5 is OFF. As in the case of FIG. 1, therefore, charge Q3=C1×Va is stored only in the first capacitor C1, and the charge Q3 is used for current drive of an organic EL element. Once the count value represented by the count signal N becomes 17 or greater, the switch control signal W3 goes active, allowing charge Q3′=(C1+C2)×Va to be stored in the first and second capacitors C1 and C2, and the charge Q3′ is used for current drive of the organic EL element. Thus, a nonlinear data-luminance characteristic is attained.

Alternatively, control may be made to turn ON the capacitor selection switch S5 to increase the combined capacitance value when the count value represented by the count signal N is equal to or less than a given threshold value, and turn OFF the capacitor selection switch S5 to decrease the combined capacitance value when the count value is greater than the threshold value. Otherwise, three or more capacitors may be selectively used according to the count signal N.

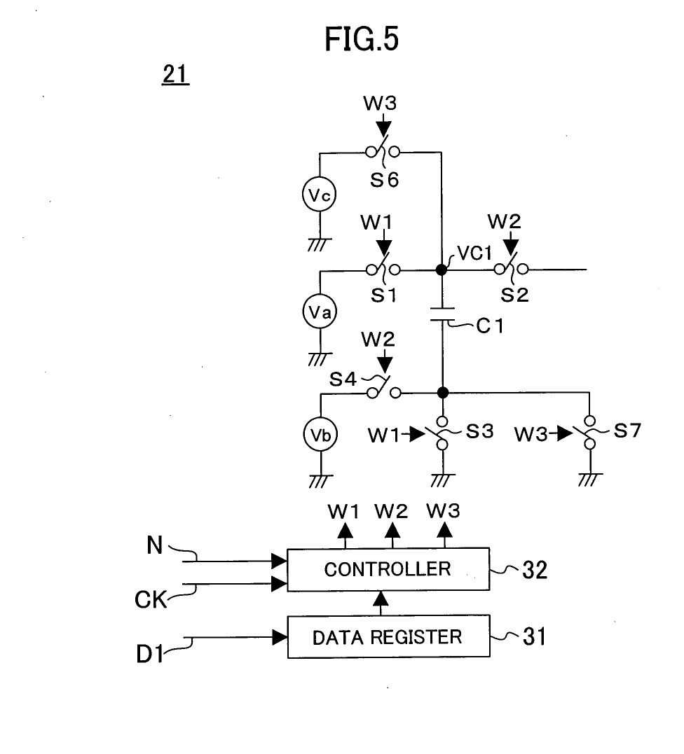

FIG. 5 shows a second alteration to the charge pump type display drive device of FIG. 1. An anode drive circuit 21 of FIG. 5, which changes the charge voltage value of the capacitor C1 according to the count signal N, includes first and second charge voltages Va and Vc (Va<Vc, for example), first and second charge switches S1 and S6, and first and second low-side voltage switches S3 and S7 for charge. The second charge voltage Vc is to be applied to the high-voltage side terminal of the capacitor C1 via the second charge switch S6 that receives a control signal W3. The low-voltage side terminal of the capacitor C1 is connected to the ground voltage Vss via the second low-side voltage switch S7 for charge that receives the control signal W3. The charge/discharge controller 32 generates the switch control signals W1 and W3 so that the first charge switch S1 and the first low-side voltage switch S3 for charge are turned ON/OFF when the count value represented by the count signal N is equal to or less than 16, for example, and the second charge switch S6 and the second low-side voltage switch S7 for charge are turned ON/OFF when it is greater than 16.

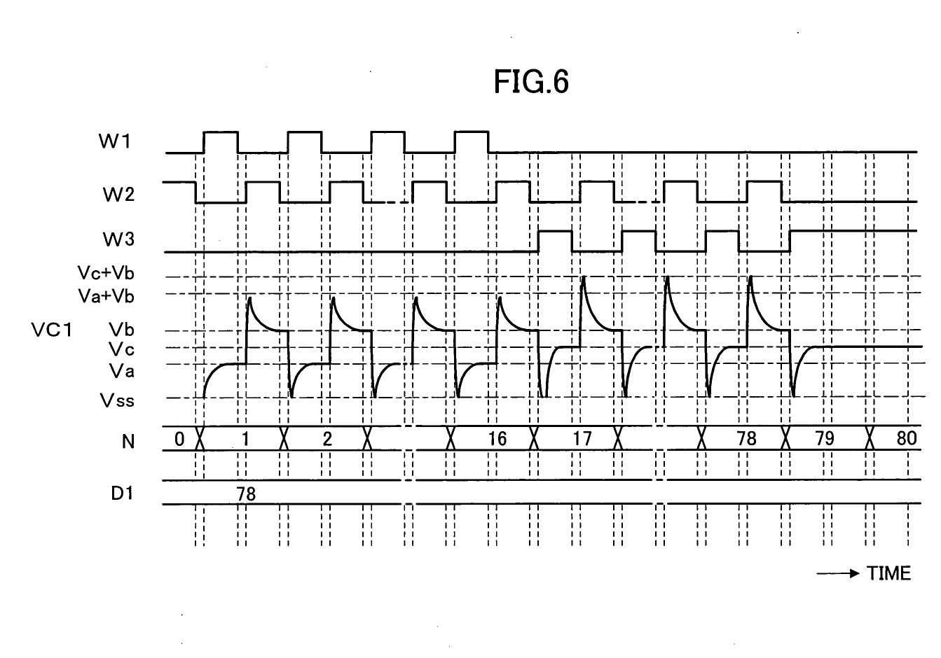

FIG. 6 is an operation timing chart of the anode drive circuit 21 of FIG. 5. During the time when the count value represented by the count signal N is any of 0 to 16, the first charge switch S1 and the first low-side voltage switch S3 for charge are turned ON/OFF. As in the case of FIG. 1, therefore, charge Q4=C1×Va is stored in the capacitor C1, and the charge Q4 is used for current drive of an organic EL element. Once the count value represented by the count signal N becomes 17 or greater, the second charge switch S6 and the second low-side voltage switch S7 for charge are turned ON/OFF. Therefore, charge Q4′=C1×Vc (>Q4) is stored in the capacitor C1, and the charge Q4′ is used for current drive of the organic EL element. Thus, a nonlinear data-luminance characteristic is attained. Moreover, without the necessity of a plurality of capacitors provided in the anode drive circuit 21, the circuit area is reduced compared with the case of FIG. 3.

Alternatively, control may be made to increase the charge voltage when the count value represented by the count signal N is equal to or less than a threshold value, and decrease the charge voltage when the count value is greater than the threshold value. As other alterations, three or more charge voltage values may be selectively used according to the count signal N. The provision of the second low-side voltage switch S7 for charge may be omitted, and the control signal supplied to the first low-side voltage switch S3 for charge may be switched from W1 to W3 depending on the count signal N.

Finally, an exemplary configuration for reducing the influence of a variation in the capacitance value of the capacitor among the n anode drive circuits 21, 22, . . . , 2n will be discussed

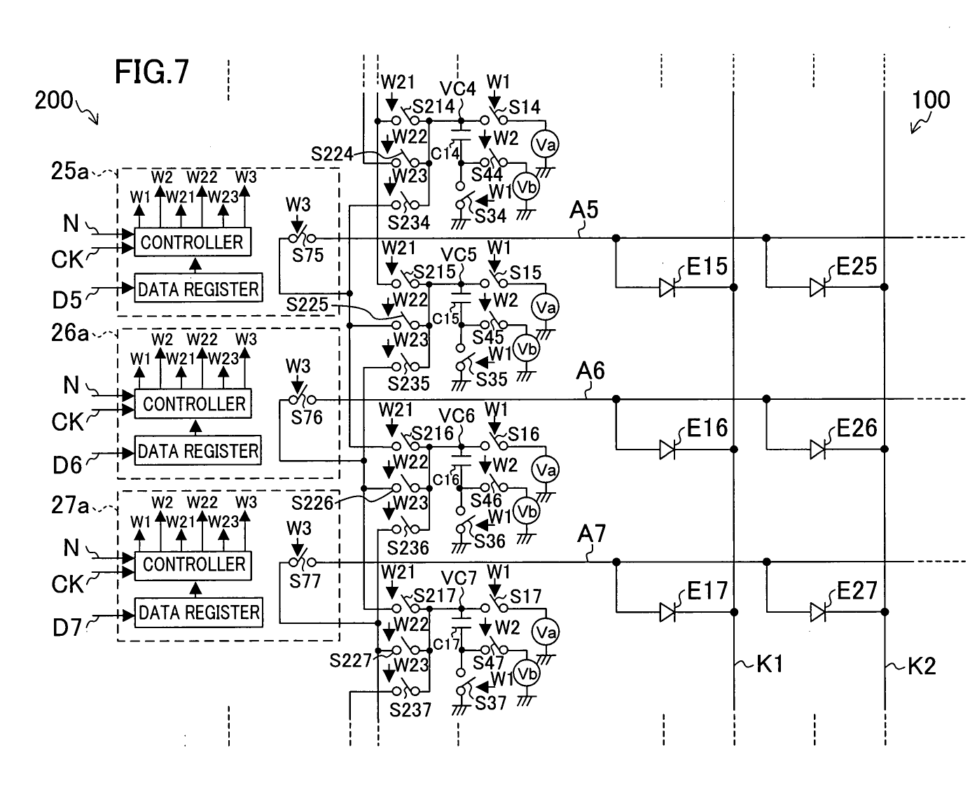

FIG. 7 shows a third alteration to the charge pump type display drive device of FIG. 1. A data driver 200 shown in FIG. 7 is configured so that assignment of the capacitors in the n anode drive circuits 21, 22, . . . , 2n to n organic EL elements constituting one row on the display panel 100 is changed every predetermined time period. Note that in FIG. 7, only a portion covering 3×2 organic EL elements E15, E16, E17, E25, E26 and E27, fifth, sixth and seventh anode lines A5, A6 and A7, and first and second cathode lines K1 and K2 is shown, together with circuits in the data driver 200 relating to this portion.

In FIG. 7, anode drive control circuits 25a, 26a and 27a for controlling the drive of the fifth, sixth and seventh anode lines A5, A6 and A7, respectively, receive data signals D5, D6 and D7, and include output control switches S75, S76 and S77.

The reference numerals C14 denotes a capacitor, S14 denotes a charge switch, S214, S224 and S234 denote discharge selection switches, S34 denotes a low-side voltage switch for charge, S44 denotes a low-side voltage switch for discharge, and VC4 denotes a capacitor voltage.

Likewise, the reference numerals C15 denotes a capacitor, S15 denotes a charge switch, S215, S225 and S235 denote discharge selection switches, S35 denotes a low-side voltage switch for charge, S45 denotes a low-side voltage switch for discharge, and VC5 denotes a capacitor voltage.

The reference numerals C16 denotes a capacitor, S16 denotes a charge switch, S216, S226 and S236 denote discharge selection switches, S36 denotes a low-side voltage switch for charge, S46 denotes a low-side voltage switch for discharge, and VC6 denotes a capacitor voltage.

The reference numerals C17 denotes a capacitor, S17 denotes a charge switch, S217, S227 and S237 denote discharge selection switches, S37 denotes a low-side voltage switch for charge, S47 denotes a low-side voltage switch for discharge, and VC7 denotes a capacitor voltage.

One of the three capacitors C14, C15 and C16 is selectively connected to the fifth anode line A5. For selection of C14, the discharge selection switch S234 and the output control switch S75 are turned ON. For selection of C15, the discharge selection switch S225 and the output control switch S75 are turned ON, and for selection of C16, the discharge selection switch S216 and the output control switch S75 are turned ON. Likewise, one of the three capacitors C15, C16 and C17 is selectively connected to the sixth anode line A6. For selection of C15, the discharge selection switch S235 and the output control switch S76 are turned ON. For selection of C16, the discharge selection switch S226 and the output control switch S76 are turned ON, and for selection of C17, the discharge selection switch S217 and the output control switch S76 are turned ON. Note that for the first anode line A1 and the n-th anode line An, a required number of additional circuits (not shown) each including a capacitor and switches are provided.

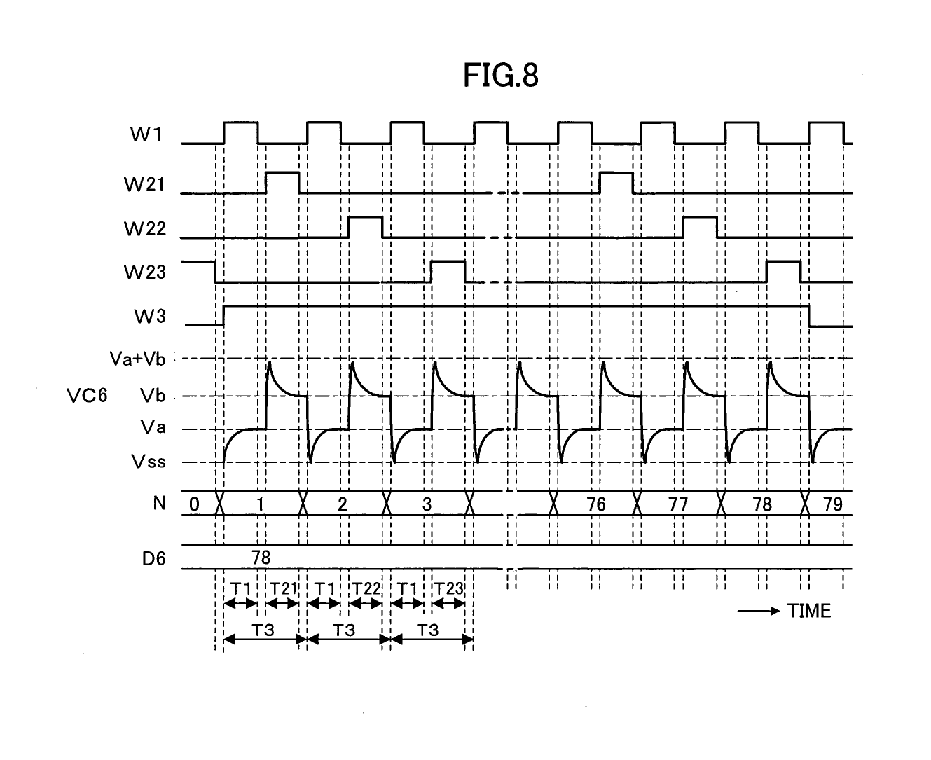

FIG. 8 is an operation timing chart of the data driver 200 of FIG. 7 at the time of driving the organic EL element E16.

As shown in FIG. 8, the control signal W3 for the output control switch S76 is active until the count value represented by the count signal N becomes equal to data (for example, 78) represented by the data signal D6, and goes inactive once the count value exceeds the data.

During time period T1 when the control signal W1 for the charge switches S15, S16 and S17 and the low-side voltage switches S35, S36 and S37 for charge is active, charges Q15, Q16 and Q17 as follows are respectively stored in the capacitors C15, C16 and C17.

Q15=C15×Va

Q16=C16×Va

Q17=C17×Va

After the switch control signal W1 has become inactive, the control signals W21 and W2 for the discharge selection switch S217 and the low-side voltage switch S47 for discharge become active during time period T21. With this, the voltage of the low-voltage side terminal of the capacitor C17 becomes Vb that is higher than the light emission threshold voltage of the organic EL element E16 with the low-side voltage switch S47 for discharge. The entire of the charge Q17 stored in the capacitor C17 is therefore fed to the organic EL element E16.

In the next charge/discharge cycle, after the switch control signal W1 has become inactive from time period T1, the control signals W22 and W2 for the discharge selection switch S226 and the low-side voltage switch S46 for discharge become active during time period T22. With this, the voltage of the low-voltage side terminal of the capacitor C16 becomes Vb that is higher than the light emission threshold voltage of the organic EL element E16 with the low-side voltage switch S46 for discharge. The entire of the charge Q16 stored in the capacitor C16 is therefore fed to the organic EL element E16.

Further, in the next charge/discharge cycle, after the switch control signal W1 has become inactive from time period T1, the control signals W23 and W2 for the discharge selection switch S235 and the low-side voltage switch S45 for discharge become active during time period T23. With this, the voltage of the low-voltage side terminal of the capacitor C15 becomes Vb that is higher than the light emission threshold voltage of the organic EL element E16 with the low-side voltage switch S45 for discharge. The entire of the charge Q15 stored in the capacitor C15 is therefore fed to the organic EL element E16.

When the period of the charge/discharge cycle is T3, the average drive current 16 of the organic EL element E16 over the time period three times as long as the period T3 is expressed by

$$\begin{matrix}I 6 = ( Q 15 + Q 16 + Q 17 ) / ( 3 \times T 3 ) \\ = ( C 15 + C 16 + C 17 ) \times Va / ( 3 \times T 3 )\end{matrix}$$

### In other words, the influence of a variation in capacitance value among the capacitors C15, C16 and C17 on the drive current value can be reduced.

Although three capacitors were selectively connected to one anode line in the configuration of FIG. 7, any other number of capacitors may be used in parallel. The assignment of capacitors to organic EL elements constituting one row on the display panel 100 may be changed every predetermined time period, and the predetermined time period may be of any given length, such as every horizontal time period, every plurality of horizontal time periods and every frame.

In the configurations described above, a plurality of switch control signals are generated individually in the charge/discharge controllers in the anode drive circuits provided for the respective anode lines. Alternatively, for reduction in circuit area, a switch control signal representing common ON/OFF timing for the plurality of anode lines may be generated by a common controller.

As described above, the charge pump type display drive device of the present invention is useful as a low-cost, small-size display drive device for a passive organic EL display panel.

While the present invention has been described in a preferred embodiment, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. A charge pump type display drive device for driving a passive display panel having a plurality of organic electroluminescence (EL) elements arranged in a matrix as pixels with no transistor for control provided inside each pixel, the device comprising:
a plurality of drive circuits provided to correspond to respective organic EL elements constituting one row on the display panel,
wherein each of the plurality of drive circuits comprises:
a capacitor having first and second terminals;
charge means for permitting the capacitor to store charge by applying a predetermined voltage to the second terminal of the capacitor while holding a voltage of the first terminal of the capacitor at a reference voltage;
discharge means for permitting the capacitor to release charge stored therein by connecting the second terminal of the capacitor to an anode of a corresponding organic EL element on the display panel while applying a voltage higher than a light emission threshold voltage of the corresponding organic EL element on the display panel to the first terminal of the capacitor so that a current flows into the corresponding organic EL element on the display panel to allow the organic EL element to emit light;
charge/discharge control means for controlling the number of times of repetition of charge/discharge of the capacitor within a time period during which organic EL elements constituting one row on the display panel are driven so as to control the light emission luminance of the corresponding organic EL element on the display panel according to a data signal given.

2. The device of claim 1, wherein each of the plurality of drive circuits further comprises means for changing a capacitance value of the capacitor according to a count value of the number of charge/discharge cycles of the capacitor within the time period during which organic EL elements constituting one row on the display panel are driven.

3. The device of claim 1, wherein each of the plurality of drive circuits further comprises means for allowing the charge means to change a value of a voltage applied to the second terminal of the capacitor according to a count value of the number of charge/discharge cycles of the capacitor within the time period during which organic EL elements constituting one row on the display panel are driven.

4. The device of claim 1, further comprising means for changing assignment of the capacitors in the plurality of drive circuits to organic EL elements constituting one row on the display panel every predetermined time period.

5. A display apparatus comprising:
a passive display panel having a plurality of organic electroluminescence (EL) elements arranged in a matrix as pixels with no transistor for control provided inside each pixel; and
a charge pump type display drive device for driving the display panel,
wherein the charge pump type display drive device comprises a plurality of drive circuits provided to correspond to respective organic EL elements constituting one row on the display panel, and
each of the drive circuits comprises:
a capacitor having first and second terminals;
charge means for permitting the capacitor to store charge by applying a predetermined voltage to the second terminal of the capacitor while holding a voltage of the first terminal of the capacitor at a reference voltage;
discharge means for permitting the capacitor to release charge stored therein by connecting the second terminal of the capacitor to an anode of a corresponding organic EL element on the display panel while applying a voltage higher than a light emission threshold voltage of the corresponding organic EL element on the display panel to the first terminal of the capacitor so that a current flows to the corresponding organic EL element on the display panel to allow the organic EL element to emit light;
charge/discharge control means for controlling the number of times of repetition of charge/discharge of the capacitor within a time period during which organic EL elements constituting one row on the display panel are driven so as to control the light emission luminance of the corresponding organic EL element on the display panel according to a data signal given.

6. The apparatus of claim 5, further comprising a scan driver for selecting cathodes of organic EL elements constituting each row on the display panel sequentially in rows.
